(19) United States
(12) Patent Application Publication
(10) Pub. No.: US 2021/0104105 A1
(43) Pub. Date: Apr. 8, 2021

(54) METHOD, DEVICE AND APPARATUS FOR DYNAMICALLY MONITORING WORKING STATE OF VEHICLE, AND STORAGE MEDIUM

(71) Applicant: CITIC Dicastal CO., LTD., Qinhuangdao (CN)

(72) Inventors: Xi LI, Qinhuangdao (CN); Zhihua ZHU, Qinhuangdao (CN); Shiwen XU, Qinhuangdao (CN); Yao DAI, Qinhuangdao (CN); Shaobing HUANG, Qinhuangdao (CN); Hongwei SHENG, Qinhuangdao (CN); Xiaoqiang LI, Qinhuangdao (CN)

(21) Appl. No.: 16/790,947

(22) Filed: Feb. 14, 2020

(30) Foreign Application Priority Data
Oct. 8, 2019 (CN) 201910951076.5

(51) Int. Cl. G07C 5/08; G01M 17/02; B60C 23/04; G07C 5/00

(52) U.S. Cl. CPC G07C 5/0808; G01M 17/02; B60C 23/0405; G07C 5/008; B60C 23/0488

(57) ABSTRACT

A method, device and apparatus for dynamically monitoring the working state of a vehicle, and a storage medium are disclosed. The method includes: waking up a monitoring unit according to a vehicle starting signal, acquiring the load of the vehicle, the tire pressure of a wheel and the temperature of a wheel hub through the monitoring unit, and determining the working state of the vehicle according to the load of the vehicle, the tire pressure of the wheel and the temperature of the wheel hub.

### CROSS-REFERENCE TO RELATED APPLICATIONS

The present application claims benefit of Chinese Patent Application No. 201910951076.5, filed on Oct. 8, 2019, the contents of which are hereby incorporated by reference in their entirety.

### BACKGROUND

With the development of economy and science and technology, smart transportation has become an important development direction of human society. How to dynamically monitor the working state of a vehicle is an important part of smart transportation.

There are limited means to obtain the load of a wheel, among which wagon balance is mostly used. Wagon balance has great limitations. First, the cost and the construction cost of wagon balance are high. Second, it is impossible to dynamically obtain the load of the vehicle anytime and anywhere. The acquisition of other working states of the vehicle is inaccurate too.

### SUMMARY

The disclosure relates to the technical field of vehicle manufacturing, in particular to a method, device and apparatus for dynamically monitoring the working state of a vehicle, and a storage medium.

In view of this, the embodiments of the disclosure expect to provide a method, device and apparatus for dynamically monitoring the working state of a vehicle, and a storage medium, which can dynamically monitor the working state of the vehicle, and are characterized by accurate data and low cost.

In order to achieve the above object, in a first aspect, the embodiments of the present disclosure provide a method for dynamically monitoring the working state of a vehicle, and the method includes:

waking up a monitoring unit according to a vehicle starting signal;

acquiring the load of the vehicle, the tire pressure of a wheel and the temperature of a wheel hub through the monitoring unit; and

determining the working state of the vehicle according to the load of the vehicle, the tire pressure of the wheel and the temperature of the wheel hub.

In one embodiment, the waking up the monitoring unit according to the vehicle starting signal includes:

obtaining the vehicle starting signal through the state of an ignition wire of the vehicle; and

waking up the monitoring unit according to the vehicle starting signal through a wireless waking-up component.

In one embodiment, the acquiring the load of the vehicle, the tire pressure of the wheel and the temperature of the wheel hub through the monitoring unit includes:

acquiring the deformation data of the vehicle hub after the vehicle hub is loaded through a deformation sensor of the monitoring unit, so as to acquire the load of the vehicle;

acquiring the tire pressure of the wheel through a pressure sensor of the monitoring unit; and

acquiring the temperature of the vehicle hub through a temperature sensor of the monitoring unit.

In one embodiment, the determining the working state of the vehicle according to the load of the vehicle, the tire pressure of the wheel and the temperature of the wheel hub includes:

determining that the working state of the vehicle is abnormal and sending out alarm information if any one of the load of the vehicle, the tire pressure of the wheel and the temperature of the wheel hub exceeds a corresponding upper limit value;

otherwise, determining that the working state of the vehicle is normal.

In one embodiment, the method further includes:

sending the determined working state of the vehicle to a vehicle cloud platform through a public mobile communication network.

In one embodiment, the method further includes:

acquiring an acceleration value of the vehicle through an acceleration sensor; and

correcting the acquired load value of the vehicle according to the acceleration value of the vehicle.

In a second aspect, the embodiments of the disclosure further provide a device for dynamically monitoring the working state of a vehicle, and the device includes a memory, a communication bus and a processor, wherein

the memory is configured to store a method program for dynamically monitoring a working state of a vehicle and acquired monitoring data;

the communication bus is configured to realize connection and communication between the memory and the processor; and

the processor is configured to execute the method program stored in the memory for dynamically monitoring the working state of the vehicle, so as to:

wake up a monitoring unit according to a vehicle starting signal;

acquire the load of the vehicle, the tire pressure of a wheel and the temperature of a wheel hub through the monitoring unit; and

determine the working state of the vehicle according to the load of the vehicle, the tire pressure of the wheel and the temperature of the wheel hub.

In a third aspect, the embodiments of the disclosure provide an apparatus for dynamically monitoring the working state of a vehicle, the apparatus includes a monitoring unit for acquiring the deformation data of a wheel hub, the tire pressure of a wheel and the temperature of the wheel hub, the apparatus further includes a processing unit for processing the deformation data, the tire pressure of the wheel and the temperature of the wheel hub and acquiring the working state of the vehicle, and the monitoring unit and the processing unit are connected.

In a fourth aspect, the embodiments of the disclosure provide an on-board computer, and the on-board computer includes a memory, a communication bus and a processor, in which

the memory is configured to store a method program for dynamically monitoring the working state of a vehicle and acquired monitoring data;

the communication bus is configured to realize connection and communication between the memory and the processor; and

the processor is configured to execute the method program stored in the memory for dynamically monitoring the working state of the vehicle to implement the steps of any one of the methods as described above.

In a fifth aspect, the embodiments of the disclosure provide a computer readable storage medium, an executable program is stored on the computer readable storage medium, and when executed by a processor, the executable program implements the steps of any one of the methods as described above.

According to the method, device and apparatus for dynamically monitoring the working state of the vehicle, and the storage medium provided by the embodiments of the disclosure, the method includes: waking up the monitoring unit according to the vehicle starting signal; acquiring the load of the vehicle, the tire pressure of the wheel and the temperature of the wheel hub through the monitoring unit; and determining the working state of the vehicle according to the load of the vehicle, the tire pressure of the wheel and the temperature of the wheel hub. It can be seen that according to the method, device and apparatus for dynamically monitoring the working state of the vehicle, and the storage medium provided by the embodiments of the disclosure, the monitoring unit including the deformation sensor, the pressure sensor and the temperature sensor is arranged for dynamic monitoring after the vehicle is started. The method, device and apparatus for dynamically monitoring the working state of the vehicle, and the storage medium can dynamically monitor the working state of the vehicle, and are characterized by accurate data and low cost.

Other beneficial effects of the embodiments of the present disclosure will be further explained in specific implementations in conjunction with the specific technical solution.

### BRIEF DESCRIPTION OF THE DRAWINGS

FIG. 1 is a flow chart of a method for dynamically monitoring the working state of a vehicle according to the embodiments of the present disclosure;

FIG. 2 is a detailed flow chart of the method for dynamically monitoring the working state of the vehicle according to the embodiments of the present disclosure;

FIG. 3 is a structural diagram of a device for dynamically monitoring the working state of a vehicle according to the embodiments of the present disclosure;

FIG. 4 is a structural diagram of an apparatus for dynamically monitoring the working state of a vehicle according to the embodiments of the present disclosure; and

FIG. 5 is a structural diagram of an on-board computer according to the embodiments of the present disclosure.

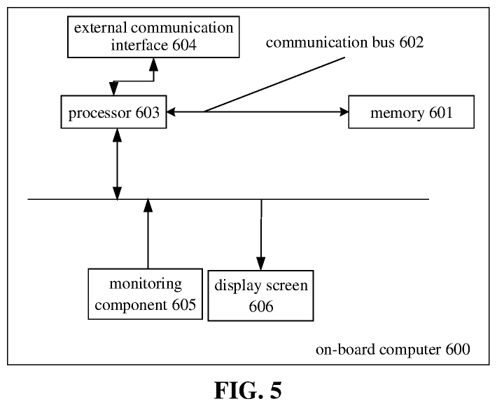

### DETAILED DESCRIPTION

The embodiments of the disclosure provide a method for dynamically monitoring the working state of a vehicle, and the method includes: a monitoring unit is woken up according to a vehicle starting signal; the load of the vehicle, the tire pressure of a wheel and the temperature of a wheel hub are acquired through the monitoring unit; and the working state of the vehicle is determined according to the load of the vehicle, the tire pressure of the wheel and the temperature of the wheel hub.

According to the method for dynamically monitoring the working state of the vehicle provided by the disclosure, the monitoring unit including a deformation sensor, a pressure sensor and a temperature sensor is arranged for dynamic monitoring after the vehicle is started. The method can dynamically monitor the working state of the vehicle, and is characterized by accurate data and low cost.

The embodiments of the disclosure further provide a device for dynamically monitoring the working state of a vehicle, and the device includes a waking-up assembly, an acquisition assembly and a determination assembly; in which

the waking-up assembly is configured to wake up a monitoring unit according to a vehicle starting signal;

the acquisition assembly is configured to acquire the load of the vehicle, the tire pressure of a wheel and the temperature of a wheel hub through the monitoring unit; and

the determination assembly is configured to determine the working state of the vehicle according to the load of the vehicle, the tire pressure of the wheel and the temperature of the wheel hub.

The embodiments of the disclosure further provide an apparatus for dynamically monitoring the working state of a vehicle, the apparatus includes a monitoring unit for acquiring the deformation data of a wheel hub, the tire pressure of a wheel and the temperature of the wheel hub, the apparatus further includes a processing unit for processing the deformation data, the tire pressure of the wheel and the temperature of the wheel hub and acquiring the working state of the vehicle, and the monitoring unit and the processing unit are connected.

The embodiments of the disclosure further provide an on-board computer, and the on-board computer includes a memory, a communication bus and a processor, in which

the memory is configured to store a method program for dynamically monitoring the working state of a vehicle and acquired monitoring data;

the communication bus is configured to realize connection and communication between the memory and the processor; and

the processor is configured to execute the method program stored in the memory for dynamically monitoring the working state of the vehicle to implement the steps of any one of the methods as described above.

The embodiments of the disclosure further provide a computer readable storage medium, an executable program is stored on the computer readable storage medium, and when executed by a processor, the executable program implements the steps of any one of the methods as described above.

The present disclosure will be described in further detail below with reference to the accompanying drawings and specific embodiments. It should be understood that the specific embodiments described herein are only for the purpose of explaining the present disclosure and are not intended to limit the present disclosure.

### First Embodiment

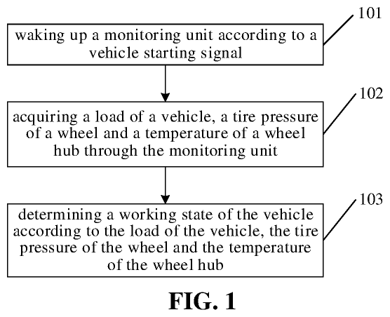

The present embodiment provides a method for dynamically monitoring the working state of a vehicle, and the method can be realized by an on-board computer or a separately installed computer. As shown in FIG. 1, the method includes:

Step 101: a monitoring unit is woken up according to a vehicle starting signal.

In an implementation mode, the waking-up of the monitoring unit according to the vehicle starting signal includes:

the vehicle starting signal is obtained through the state of an ignition wire of the vehicle; and

the monitoring unit is woken up according to the vehicle starting signal through a wireless waking-up component.

For the sake of power saving, the monitoring unit is generally in a sleep state before being awakened. Moreover, after being awakened, the monitoring unit will re-enter the sleep state if the response of the on-board computer is not received within a preset period of time. In the present embodiment, after being awakened, data reporting is conducted once every 5 minutes, and the response is received every time data reporting is conducted. When no response is received for 3 consecutive times, the monitoring unit re-enters the sleep state. The wireless waking-up component herein can adopt the principle of Radio Frequency (RF), i.e. the frequency range of a wireless signal is between 300 kHz and 300 GHz, which is a widely used wireless communication signal.

Step 102: the load of the vehicle, the tire pressure of a wheel and the temperature of a wheel hub are acquired through the monitoring unit.

In one implementation mode, the acquisition of the load of the vehicle, the tire pressure of the wheel and the temperature of the wheel hub through the monitoring unit includes:

the deformation data of the vehicle hub after the vehicle hub is loaded is acquired through a deformation sensor of the monitoring unit, so as to acquire the load of the vehicle;

the tire pressure of the wheel is acquired through a pressure sensor of the monitoring unit; and

the temperature of the vehicle hub is acquired through a temperature sensor of the monitoring unit.

Herein, when the vehicle hub is loaded, there will be slight deformation, which can be detected by the deformation sensor. Then, the load of the vehicle hub, that is, the load of the vehicle, can be calculated based on the detected slight deformation of the hub. The pressure sensor can be arranged on the inner wall of the wheel, and the temperature sensor can be arranged on the surface of the vehicle hub.

In one implementation mode, the method further includes:

an acceleration value of the vehicle is acquired through an acceleration sensor; and

the acquired load value of the vehicle is corrected according to the acceleration value of the vehicle.

Since the deformation of the wheel hub of the vehicle will change even if the load of the vehicle does not change in the acceleration process, the obtained load value of the vehicle needs to be corrected according to the acceleration value.

Step 103: the working state of the vehicle is determined according to the load of the vehicle, the tire pressure of the wheel and the temperature of the wheel hub.

In one implementation mode, the determination of the working state of the vehicle according to the load of the vehicle, the tire pressure of the wheel and the temperature of the wheel hub includes:

the working state of the vehicle is determined to be abnormal and alarm information is set out if any one of the load of the vehicle, the tire pressure of the wheel and the temperature of the wheel hub exceeds a corresponding upper limit value;

otherwise, the working state of the vehicle is determined to be normal.

In one implementation mode, the method further includes:

the determined working state of the vehicle is sent to a vehicle cloud platform through a public mobile communication network.

In this way, the vehicle can be controlled and dispatched through the cloud platform, for example, transportation companies can manage truck drivers through the cloud platform, and the data of the cloud platform can also be archived for the public security department and other government departments to consult.

The public mobile communication network herein may be the second-generation (2G) global system for mobile communication (GSM)/code division multiple access (CDMA), the third-generation (3G) time division-synchronous code division multiple access (TD-SCDMA)/code division multiple access 2000 (CDMA2000)/wideband code division multiple access (WCDMA) and the fourth-generation (4G) time division long term evolution (TD-LTE)/frequency division duplexing long term evolution (FDD-LTE), but is not limited thereto, and may also be other networks capable of realizing communication.

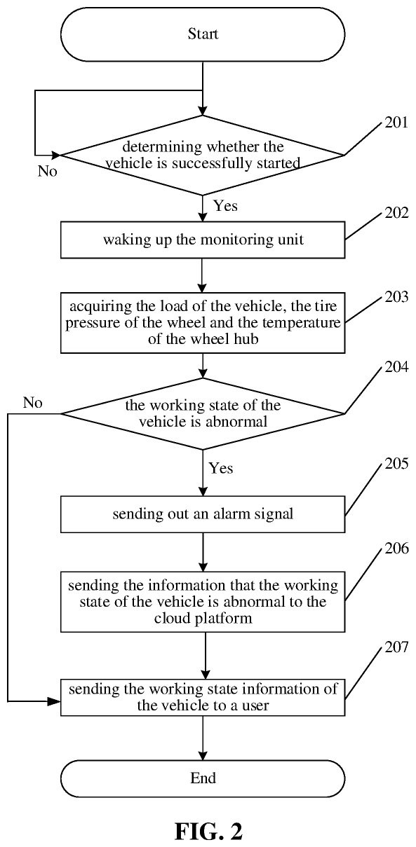

Further, in order to better understand the present embodiment, the following describes the specific flow of the method for dynamically monitoring the working state of a vehicle according to the embodiment of the present disclosure, as shown in FIG. 2, the flow includes:

Step 201: whether the vehicle is started is confirmed. The vehicle starting signal is obtained through the state of the ignition wire of the vehicle. If yes, step 202 is executed, otherwise the last step is returned.

Step 202: the monitoring unit is woken up. The monitoring unit is woken up through the wireless waking-up component.

Step 203: the load of the vehicle, the tire pressure of the wheel and the temperature of the wheel hub are acquired. The deformation data of the vehicle hub after the vehicle hub is loaded are acquired through the deformation sensor of the monitoring unit, so as to acquire the load of the vehicle; the tire pressure of the wheel is acquired through the pressure sensor of the monitoring unit; and the temperature of the vehicle hub is acquired through the temperature sensor of the monitoring unit.

Step 204: whether the working state of the vehicle is abnormal is determined. The working state of the vehicle is determined to be abnormal and alarm information is sent out if any one of the load of the vehicle, the tire pressure of the wheel and the temperature of the wheel hub exceeds a corresponding upper limit value; otherwise the working state of the vehicle is determined to be normal.

If the working state is abnormal, step 205 is executed, otherwise step 207 is executed.

Step 205: an alarm signal is sent out. The alarm signal may be an acousto-optic alarm.

Step 206: the information that the working state of the vehicle is abnormal is sent to the cloud platform. In order to save the resources of the cloud platform, only the information that the working state of the vehicle is abnormal is sent to the cloud platform, and normal information is not sent.

Step 207: the working state information of the vehicle is sent to a user. For example, it is sent to a display screen of a center console of the vehicle. The sending principle may be ZigBee protocol.

### Second Embodiment

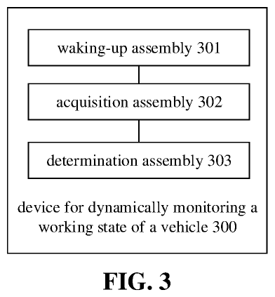

The present embodiment provides a device for dynamically monitoring the working state of a vehicle, as shown in FIG. 3, the device 300 includes a waking-up assembly 301, an acquisition assembly 302 and a determination assembly 303; in which

the waking-up assembly 301 is configured to wake up a monitoring unit according to a vehicle starting signal;

the acquisition assembly 302 is configured to acquire the load of the vehicle, the tire pressure of a wheel and the temperature of a wheel hub through the monitoring unit; and

the determination assembly 303 is configured to determine the working state of the vehicle according to the load of the vehicle, the tire pressure of the wheel and the temperature of the wheel hub.

In one implementation mode, the waking-up assembly 301 is specifically configured to:

obtain the vehicle starting signal through the state of an ignition wire of the vehicle; and

wake up the monitoring unit according to the vehicle starting signal through a wireless waking-up component.

In one implementation mode, the acquisition assembly 302 is specifically configured to:

acquire the deformation data of the vehicle hub after the vehicle hub is loaded through a deformation sensor of the monitoring unit, so as to acquire the load of the vehicle;

acquire the tire pressure of the wheel through a pressure sensor of the monitoring unit; and

acquire the temperature of the vehicle hub through a temperature sensor of the monitoring unit.

In one implementation mode, the acquisition assembly 302 is further configured to:

acquire an acceleration value of the vehicle through an acceleration sensor; and

correct the acquired load value of the vehicle according to the acceleration value of the vehicle.

In one implementation mode, the determination assembly 303 is further configured to:

determine that the working state of the vehicle is abnormal and send out alarm information if any one of the load of the vehicle, the tire pressure of the wheel and the temperature of the wheel hub exceeds a corresponding upper limit value;

otherwise, determine that the working state of the vehicle is normal.

In one implementation mode, the determination assembly 303 is further configured to:

send the determined working state of the vehicle to a vehicle cloud platform through a public mobile communication network.

The device 300 in the embodiment of the present disclosure may be a device arranged in the vehicle or a separate device connected to and communicating with the vehicle.

In some embodiments, the device 300 in the embodiment of the present disclosure may be used to implement the method for dynamically monitoring the working state of a vehicle described in the above embodiment, and of course may also include assemblies for implementing any procedure and/or step in the method for dynamically monitoring the working state of a vehicle described in the above embodiment, which will not be described again for brevity.

The description of the above device embodiment is similar to the description of the above method embodiment and has similar beneficial effects as the method embodiment. For technical details not disclosed in the device embodiment of the present disclosure, please refer to the description of the method embodiment of the present disclosure.

Each assembly included in the embodiment of the disclosure can be realized by a processor in the vehicle; of course, they can also be realized by a logic circuit in the vehicle. In the implementation process, the processor may be a central processing unit (CPU), a microprocessor (MPU), a digital signal processor (DSP), a field programmable gate array (FPGA), etc.

### Third Embodiment

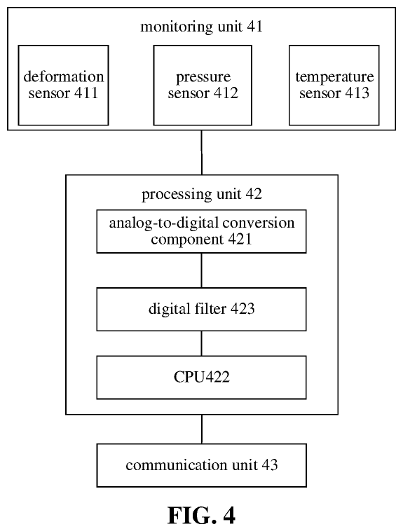

The embodiment of the disclosure also provides an apparatus for dynamically monitoring the working state of a vehicle, as shown in FIG. 4, the apparatus includes a monitoring unit 41 and a processing unit 42, the monitoring unit 41 includes a deformation sensor 411, a pressure sensor 412 and a temperature sensor 413, and the processing unit 42 is a micro-control unit (MCU).

The monitoring unit 41 is configured to monitor the load of the vehicle, the tire pressure of a wheel and the temperature of a wheel hub.

The processing unit 42 is configured to acquire the load of the vehicle, the tire pressure of the wheel and the temperature of the wheel hub through the monitoring unit 41, and determining the working state of the vehicle.

The monitoring unit 41 is connected with the processing unit 42.

Specifically, the processing unit 42 includes an analog-to-digital conversion component 421 and a CPU 422, an input end of the analog-to-digital conversion component 421 is connected with the monitoring unit 41, and an output end of the analog-to-digital conversion component 421 is connected with the CPU 422.

The analog-to-digital conversion component 421 is configured to convert analog signals collected by the deformation sensor 411, the pressure sensor 412, and the temperature sensor 413 into digital signals.

More specifically, the processing unit 42 further includes a digital filter 423, an input end of the digital filter 423 is connected with the analog-to-digital conversion component 421, and an output end of the digital filter 423 is connected with the CPU 422. The digital filter 423 is a device which converts a group of input digital sequence into another group of output digital sequence through certain operations. Assuming that the input of the digital filter 423 is X(n) and the output is Y(n), the relationship between the input sequence and the output sequence can be expressed by a difference equation as follows:

$$y ( n ) = {\sum }_{k = 0}^{M} {a}_{k} x ( n - k ) - {\sum }_{k = 1}^{N} {b}_{k} y ( n - k ) \qquad ( 1 )$$

Different parameters a_{K} and b_{K} can realize different digital filters 423 such as low-pass, high-pass, band-pass, and band-stop types. In the present disclosure, it is designed to be a low-pass filter, so that interference of power frequency or high frequency can be filtered out, and effective data can be screened out. The selection of parameters a_{K} and b_{K} depends on the calibration of the sensors and the actual test value.

Further, the apparatus includes a communication unit 43.

The communication unit 43 is configured to transmit the acquired load of the vehicle, the tire pressure of the wheel, the temperature of the wheel hub and the determined working state of the vehicle to the user, for example, to a display screen of a center console of the vehicle. The communication unit 43 includes one or more of an RF device and a ZigBee protocol device, i.e., the transmission principle is wireless radio frequency or ZigBee protocol.

The communication unit 43 is also configured to send information to a cloud platform, and the sending principle is through a public mobile communication network or narrow band Internet of Things (NB-IoT). That is, the communication unit may include one or more of RF, ZigBee, 2G/3G/4G and NB-IoT communication assemblies.

### Fourth Embodiment

As shown in FIG. 6, the embodiments of the disclosure further provide an on-board computer, and the on-board computer 600 includes a memory 601, a communication bus 602 and a processor 603, in which

the memory 601 is configured to store a method program for dynamically monitoring the working state of a vehicle and acquired deformation data;

the communication bus 602 is configured to realize connection and communication between the memory and the processor 60; and

the processor 603 is configured to execute the method program stored in the memory for dynamically monitoring the working state of the vehicle to implement the steps of the method as described in the first embodiment.

Specifically, the processor 603 may be a multi-core processor based on a reduced instruction set computer (RISC) architecture, and the memory 601 may be a high-capacity magnetic memory.

Specifically, the on-board computer 600 further includes an external communication interface 604, a monitoring component 605 and a display screen 606, in which

the external communication interface 604 may be used to communicate with outside, an external terminal including a server or a client, and the external communication interface 604 may be a wired interface or a wireless interface;

the monitoring component 605 may be configured to monitor the load of the vehicle, the tire pressure of a wheel and the temperature of a wheel hub; and

the display screen 606 may be configured to display the acquired load of the vehicle, the tire pressure of the wheel, the temperature of the wheel hub, and the determined working state of the vehicle.

The description of the above on-board computer embodiment is similar to the description of the above method embodiment and has similar beneficial effects as the method embodiment. For technical details not disclosed in the on-board computer of the present embodiment, please refer to the description of the method embodiment of the present disclosure.

### Fifth Embodiment

The embodiment of the disclosure provides a computer readable storage medium, an executable program is stored on the computer readable storage medium, and when executed by a processor, the executable program implements the steps of the method for dynamically monitoring the working state of a vehicle as described in the first embodiment.

The computer readable storage medium may be a high capacity magnetic memory.

The description of the above computer readable storage medium embodiment is similar to the description of the above method embodiment and has similar beneficial effects as the method embodiment. For technical details not disclosed in the computer readable storage medium of the present embodiment, please refer to the description of the method embodiment in the present disclosure.

### Sixth Embodiment

The embodiment provides a wheel assembly of a vehicle, and the wheel assembly includes a wheel hub, a tire and the apparatus for dynamically monitoring the working state of the vehicle described in the third embodiment. The deformation sensor in the apparatus is installed on the outer circumferential surface of a rim of the wheel hub, and the tire is installed on the wheel hub and covers the deformation sensor. The pressure sensor in the apparatus is installed on a hub surface in the tire, and the temperature sensor in the apparatus is installed on the surface of the hub.

To facilitate detection, the deformation sensor, the pressure sensor and the temperature sensor are installed on the wheel hub, and other components in the apparatus for dynamically monitoring the working state of the vehicle may be installed on the wheel hub, or may be installed on other parts of the vehicle independent of the wheel hub.

Further, the wheel assembly herein may include only a part of the apparatus for dynamically monitoring the working state of the vehicle. Because data can be transmitted wirelessly or through non-rigid connection such as flexible wires, the processing unit may be installed separately from the wheel assembly.

### Seventh Embodiment

The embodiment provides an automobile, and the automobile includes an electronic control unit, a center console and the wheel assembly described in the sixth embodiment, in which the apparatus for dynamically monitoring the working state of a vehicle in the wheel assembly is connected with the electronic control unit, and the apparatus for dynamically monitoring the working state of a vehicle in the wheel assembly is connected with the center console.

To support the apparatus for dynamically monitoring the working state of a vehicle according to the third embodiment, the electronic control unit may be a conventional electronic control unit in a vehicle, a specially set electronic control unit, or a computer separately set up to be independent of the electronic control unit of the vehicle. Therefore, the electronic control unit herein should not be understood by its name, but should be understood as a computer apparatus supporting the apparatus for dynamically monitoring the working state of a vehicle.

The center console herein can receive the corresponding information about the working state of a vehicle through a user screen, including the alarm information.

It should be noted that herein, the term “comprise”, “include” or any other variation thereof is intended to cover a non-exclusive inclusion, such that a process, method, article, or device which includes a list of elements includes not only those elements but also other elements not expressly listed, or elements inherent to such process, method, article, or device. Without further restrictions, an element defined by the statement “comprise/include(s) a . . . ” does not exclude the presence of another identical element in a process, method, article, or device which includes the element.

In the description of the embodiments of the present disclosure, unless otherwise specified and limited, the term “connect” should be broadly understood, for example, it can be electrical connection, it can also be internal communication between two elements; it can be direct connection, it can also be indirect connection through an intermediate medium; and for those skilled in the art, the specific meaning of the above term can be understood according to the specific situation.

In the embodiments of the present disclosure, the terms “first, second, and third” are only used to distinguish similar objects and do not represent a specific ordering of objects. It is understood that “first, second, and third” can be interchanged if allowed.

It should be understood that references throughout the specification of “one embodiment” or “some embodiments” mean that specific features, structures, or characteristics related to the embodiment are included in at least one embodiment of the present disclosure. Therefore, references of “in one embodiment” or “in some embodiments” throughout the specification are not necessarily related to the same embodiment. In addition, these specific features, structures, or characteristics may be combined in any suitable manner in one or more embodiments. It should be understood that in various embodiments of the present disclosure, the sequence numbers of the above-mentioned processes do not mean the execution sequence, and the execution sequence of each process should be determined by its function and internal logic, and should not constitute any limitation on the implementation process of the embodiments of the present disclosure. The above-mentioned sequence numbers of the embodiments of the present disclosure are for description only and do not represent the advantages and disadvantages of the embodiments.

In the several embodiments provided in the present application, it should be understood that the disclosed apparatus and method may be implemented in other ways. The apparatus embodiment described above is only schematic. For example, the division of the assemblies is only a logic function division. In actual implementation, there may be other division methods, for instance, multiple assemblies or components may be combined or integrated into another system, or some features may be ignored or not executed. In addition, the coupling, direct coupling or communication connection between the components shown or discussed may be indirect coupling or communication connection through some interfaces, apparatuses or assemblies, and may be electrical, mechanical or other forms.

The assemblies described above as separate components may or may not be physically separated, and the components displayed as assemblies may or may not be physical assemblies; they can be located in one place or distributed on multiple network assemblies; and some or all of the assemblies can be selected according to actual needs to achieve the purpose of the present embodiment.

In addition, all the functional assemblies in various embodiments of the present disclosure can be integrated into one processing assembly, or each functional assembly can be separately used as one assembly, or two or more functional assemblies can be integrated into one assembly; and the above-mentioned integrated assemblies can be implemented either in the form of hardware or in the form of hardware and software functional assemblies.

Those skilled in the art can understand that all or part of the steps for implementing the above method embodiment can be completed by hardware related to program instructions, the aforementioned program can be stored in a computer readable storage medium, and when executed, the program performs the steps included in the above method embodiment; and the aforementioned storage media include various media which can store program codes, such as a mobile storage apparatus, a read only memory (ROM), a random access memory (RAM), a magnetic disk or an optical disk.

Alternatively, the above integrated assemblies of the present disclosure may be stored in a computer readable storage medium if implemented in the form of software functional assemblies and sold or used as independent products. Based on this understanding, the technical scheme of the embodiment of the present disclosure in essence or the part that contributes to the prior art can be embodied in the form of a software product. The computer software product is stored in a storage medium and includes several instructions to cause an electronic apparatus (which may be a personal computer, a server, or a network apparatus, etc.) to perform all or part of the methods described in various embodiments of the present disclosure. The aforementioned storage media include various media which can store program codes, such as a removable storage apparatus, a ROM, a RAM, a magnetic disk or an optical disk. Thus, the embodiments of the present disclosure are not limited to any specific combination of hardware and software.

The above are only preferred embodiments of the present disclosure and are not intended to limit the scope of protection of the present disclosure. Any modification, equivalent substitution and improvement made within the spirit and principles of the present disclosure shall be included in the scope of protection of the present disclosure.

1. A method for dynamically monitoring a working state of a vehicle, comprising:
waking up a monitoring unit according to a vehicle starting signal;
acquiring a load of the vehicle, a tire pressure of a wheel and a temperature of a wheel hub through the monitoring unit; and
determining the working state of the vehicle according to the load of the vehicle, the tire pressure of the wheel and the temperature of the wheel hub.

2. The method according to claim 1, wherein the waking up the monitoring unit according to the vehicle starting signal comprises:
obtaining the vehicle starting signal through the state of an ignition wire of the vehicle; and
waking up the monitoring unit according to the vehicle starting signal through a wireless waking-up component.

3. The method according to claim 2, wherein the acquiring the load of the vehicle, the tire pressure of the wheel and the temperature of the wheel hub through the monitoring unit comprises:
acquiring the deformation data of the vehicle hub after the vehicle hub is loaded through a deformation sensor of the monitoring unit, so as to acquire the load of the vehicle;
acquiring the tire pressure of the wheel through a pressure sensor of the monitoring unit; and
acquiring the temperature of the vehicle hub through a temperature sensor of the monitoring unit.

4. The method according to claim 3, wherein the determining the working state of the vehicle according to the load of the vehicle, the tire pressure of the wheel and the temperature of the wheel hub comprises:
determining that the working state of the vehicle is abnormal and sending out an alarm information if any one of the load of the vehicle, the tire pressure of the wheel and the temperature of the wheel hub exceeds a corresponding upper limit value;
otherwise, determining that the working state of the vehicle is normal.

5. The method according to claim 4, further comprising:
sending the determined working state of the vehicle to a vehicle cloud platform through a public mobile communication network.

6. The method according to claim 5, further comprising:
acquiring an acceleration value of the vehicle through an acceleration sensor; and
correcting the acquired load of the vehicle according to the acceleration value of the vehicle.

7. A device for dynamically monitoring a working state of a vehicle, wherein the device comprises a memory, a communication bus and a processor, wherein:
the memory is configured to store a method program for dynamically monitoring a working state of a vehicle and acquired monitoring data;
the communication bus is configured to realize connection and communication between the memory and the processor; and
the processor is configured to execute the method program stored in the memory for dynamically monitoring the working state of the vehicle, so as to:
wake up a monitoring unit according to a vehicle starting signal;
acquire a load of the vehicle, a tire pressure of a wheel and a temperature of a wheel hub through the monitoring unit; and
determine the working state of the vehicle according to the load of the vehicle, the tire pressure of the wheel and the temperature of the wheel hub.

8. A computer readable storage medium, wherein an executable program is stored on the computer readable storage medium, and when executed by a processor, the executable program implements a method for dynamically monitoring a working state of a vehicle, the method comprising:
waking up a monitoring unit according to a vehicle starting signal;
acquiring a load of the vehicle, a tire pressure of a wheel and a temperature of a wheel hub through the monitoring unit; and
determining the working state of the vehicle according to the load of the vehicle, the tire pressure of the wheel and the temperature of the wheel hub.
